(19) United States
(12) Patent Application Publication
(10) Pub. No.: US 2005/0152309 A1
(43) Pub. Date: Jul. 14, 2005

(54) Communications system and communications apparatus

(75) Inventor: Shingo Kamiya, Hamamatsu-shi (JP)

Correspondence Address: PILLSBURY WINTHROP SHAW PITTMAN LLP, 725 S. FIGUEROA STREET, SUITE 2800, LOS ANGELES, CA, 90017, US

(73) Assignee: Yamaha Corporation, Hamamatsu-shi (JP)

(21) Appl. No.: 11/012,667

(22) Filed: Dec. 15, 2004

(30) Foreign Application Priority Data
Dec. 15, 2003 (JP) P2003-417328

(51) Int. Cl. H04Q 7/00

(52) U.S. Cl. 370/328; 370/338

(57) ABSTRACT

The remote controller inserts the IP address IP-user of the remote controller into an infrared signal and transmits the infrared signal to the karaoke terminal as a service terminal. The karaoke terminal uses the IP address IP-user extracted from the infrared signal to perform communications with the remote controller via a LAN and a wireless access point.

### BACKGROUND OF THE INVENTION

The present invention relates to a communications system and communications apparatus which utilize a wireless network such as a wireless LAN.

A system has been proposed in which a remote controller is provided with a wireless LAN feature as well as a feature for remote control over target apparatus such as a television set and communications are made between the remote controller and the LAN. For example, Japanese Patent Laid-Open No. 2003-289516 discloses a medical care information display assistance system where a television set operated with a remote controller is arranged at each sickbed and selection is made on the remote controller between a television broadcast and medical care information provided by a hospital server and where charging information corresponding to the cumulative hours in each period from the start of selection to the end of selection of a television broadcast is accumulated into the remote controller, and the accumulated charging information is transmitted to the hospital server via the wireless LAN.

Assume that a remote controller can perform communications with a television set via a wireless LAN in the system described in Japanese Patent Laid-Open No. 2003-289516 mentioned above. It will be possible to transmit/receive huge data which cannot be transmitted by way of for example an infrared signal for remote operation between a remote controller and a television set, thus providing a more useful system. In such a system, a remote controller stores the IP address of a television set as a communicating party and the television set stores the IP address of the remote controller as a communicating party, and each party uses the IP address of the other party to perform communications. Generally, in a hospital, an inpatient does not watch a television set installed at the sickbed of another by using a remote controller. There is a fixed relationship between a remote controller which performs remote operation and a service terminal (television set) which provides a certain service to the user by way of the remote operation on the remote controller. Thus, the operation of storing the IP address of respective communicating parties into the remote controller and a service terminal has to be made only once.

However, in a system where the relationship between a remote controller and a service terminal is not always fixed, it is necessary to store the IP address of the communicating party each time the correspondence between a remote controller as a user terminal and a service terminal changes. This is extremely inconvenient.

### SUMMARY OF THE INVENTION

The invention has been accomplished in view of the aforementioned circumstances and has as an object to provide a technology which will allow the communication address of each communicating party to be recognized between a remote controller as a user terminal and a service terminal without intervention of the user.

In order to solve the aforesaid object, the invention is characterized by having the following arrangement.

(1) A communications system comprising:
a network including a wireless access point;
a plurality of service terminals that are respectively connected to the network and respectively provided with a short range wireless receivers that receive a radio signal; and
a movable user terminal that includes a short range wireless transmitter for transmitting a radio signal and a wireless network connection unit that performs wireless communication with the wireless access point,
wherein, when the short range wireless receiver of one of the plurality of service terminals receives the radio signal representing identification information of the movable user terminal transmitted by the short range wireless transmitter, the one of the plurality of service terminals transmits a communication address of the one of the plurality of service terminals to the movable user terminal specified by the identification information through the network, and the movable user terminal are communicated with the one of the plurality of service terminals through the network with using the communication address.

(2) The communications system according to (1), wherein the network is LAN, the communication address is an IP address of the one of the plurality of service terminals and the identification information is an IP address of the movable user terminal.

(3) The communications system according to (1), wherein the short range wireless transmitter transmits the identification information to the short range wireless receiver through a infrared data communication.

(4) A communications apparatus comprising:
a short range wireless receiver that receives a radio signal;
a communications unit that performs communications via a network; and
a controller that transmits, upon receiving the radio signal representing identification information through the short range wireless receiver, a communication address of the communications apparatus to a device identified by the identification information through the network by way of the communications unit, and performs communications with the device through the network.

(5) The communications apparatus according to (4), wherein the network is LAN, the communication address is an IP address of the communications apparatus and the identification information is an IP address of the device.

(6) The communications apparatus according to (4), wherein the short range wireless receiver receives an infrared radio signal.

(7) A communications apparatus comprising:
a wireless network connection unit that performs wireless communications with a wireless access point provided on a network;
a short range wireless transmitter that transmits a radio signal; and
a controller that transmits identification information of the communications apparatus through the short range wireless transmitter, receives a communication address transmitted by a service terminal which has received the identification information through the wireless network connection unit via the network and the wireless access point, and performs communications with the service terminal which has received the identification information by using the communication address.

(8) The communications apparatus according to (7), wherein the network is LAN, the communication address is an IP address of the service terminal and the identification information is an IP address of the communications apparatus.

(9) The communications apparatus according to (7), wherein the short range wireless transmitter transmits an infrared radio signal.

(10) A method of communication between a service terminal and a movable user terminal, wherein the service terminal is connected to a network including a wireless access point and includes a short range wireless receiver for receiving a radio signal, and a movable user terminal includes a short range wireless transmitter for transmitting a radio signal and a wireless network connection unit that performs wireless communication with the wireless access point, the method comprising:
transmitting the radio signal representing identification information of the movable user terminal by the short range wireless transmitter;
receiving the radio signal representing identification information by the short range wireless receiver;
transmitting a communication address of the service terminal to the movable user terminal specified by the identification information through the network;
receiving the communication address by the wireless network connection unit; and
performing wireless communication between the service terminal and the movable user terminal through the network with using the communication address.

### BRIEF DESCRIPTION OF THE DRAWINGS

FIG. 1 shows the configuration of a karaoke system as an embodiment of a communications system of the invention;

FIG. 2 is a block diagram showing the functional blocks of a karaoke terminal in the system;

FIG. 3 is a block diagram showing the functional blocks of a remote controller in the system; and

FIG. 4 is a plan view showing the external view of the remote controller.

### DETAILED DESCRIPTION OF PREFERRED EMBODIMENTS

Embodiments of the invention are described below referring to drawings.

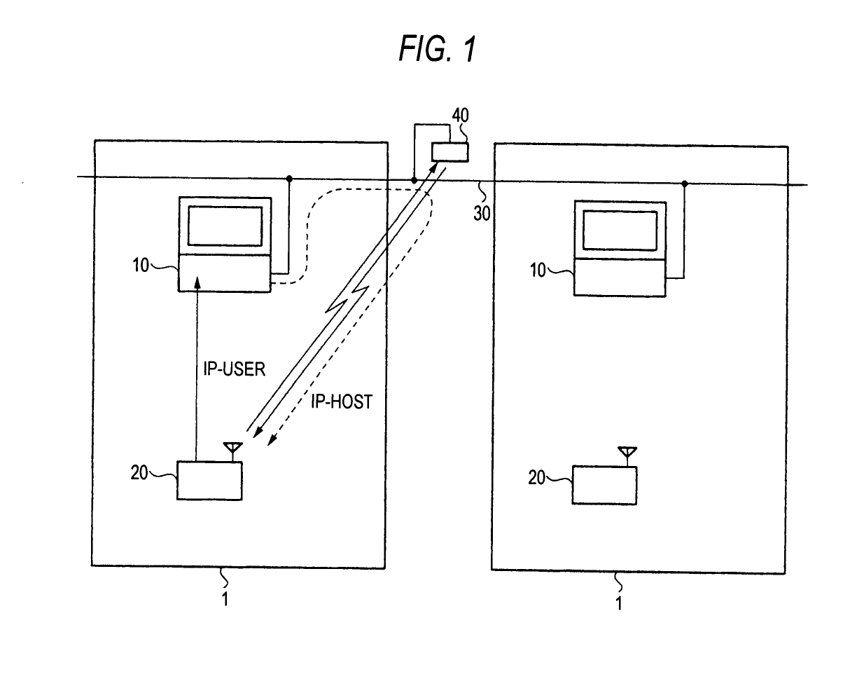

FIG. 1 shows the configuration of a karaoke system as a communications system according to an embodiment of the invention. The karaoke system includes a plurality of karaoke terminals 10 respectively installed in the rooms 1 of a karaoke lounge, a plurality of remote controllers 20 and a LAN 30 for interconnecting the karaoke terminals 10. A wireless access point 40 is connected to the LAN 30. The remote controller 20 has a function of remotely operating the nearest karaoke terminal 10 and functions as a wireless LAN for performing bidirectional communications with an arbitrary karaoke terminal 10 via the wireless access point 40 and the LAN 30. The remote controller 20 makes it easy to take anywhere. For example, a portable (movable) telephone may be used as the remote controller 20.

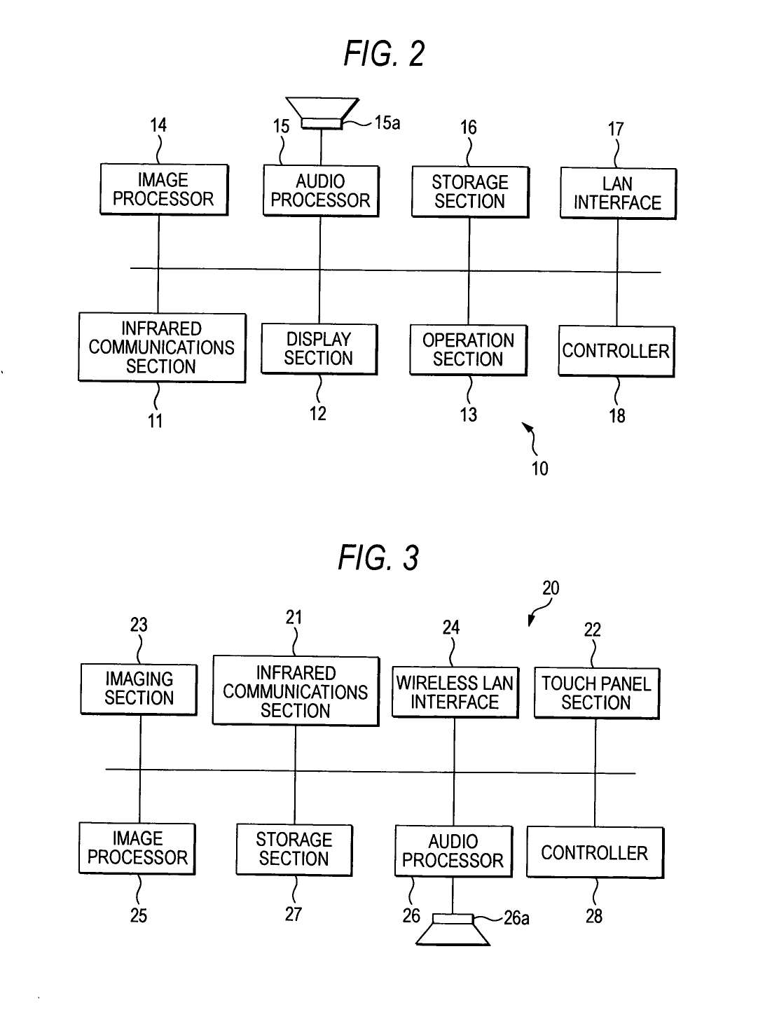

FIG. 2 is a block diagram showing the functional blocks of the karaoke terminal 10. In FIG. 2, an infrared communications section 11 receives an infrared signal for remote operation transmitted from the remote controller 20. A display section 12 displays the words of a karaoke tune being played, a BGV (background image) and a commercial message. The operation section 13 includes various operation elements such as a volume control provided on the front of the main unit of the karaoke terminal 10 and a circuit for detecting the operation of the elements. An image processor 14 synthesizes the image information to be displayed on the display section 12. An audio processor 15 generates an instrumental sound and a back chorus sound for karaoke performance and outputs the generated sounds from a loudspeaker 15a. A storage section 16 includes a volatile memory such as a RAM, a nonvolatile memory such as a ROM, and an HDD. A control program and various types of data are stored in the nonvolatile memory in the storage section 16. An IP address IP-host for uniquely identifying the karaoke terminal 10 is stored in the nonvolatile memory. The volatile memory in the storage section 16 is used as a work area of the controller 18 and an area for temporarily storing the tune data for a karaoke tune. An area for storing the IP address of the remote controller 20 as a communicating party is provided in the volatile memory. The HDD stores the tune data of a plurality of karaoke tunes and image data for karaoke background images. Tune data corresponding to a single tune includes a tune data track and a words data track. The tune data track includes stream data obtained by encoding for example an audio signal of a karaoke tune performer in accordance with the MP3 (MPEG 1 layer 3) system. The image data for a karaoke background image is for example an encoded moving picture data according to the MPEG system. The image data includes the data which corresponds to individual tunes and the data used in common for a plurality of tunes which belong to the same genre. These data are used as appropriate depending on the tune to be played. The aforementioned tune data and image data for a karaoke background image are delivered from a center (not shown) and stored into the HDD. A LAN interface 17 is connected to the LAN 30 and controls communications made via the LAN 30. A controller 18 controls each section in the karaoke terminal 10 in accordance with the control program stored in the storage section 16.

Primary controls by the controller 18 include control in accordance with an instruction from the remote controller 20 received by the infrared communications section 11, control in accordance with the operation of the operation section 13, and control in accordance with an instruction from other apparatus received via the LAN interface 17. The primary control in accordance with an instruction from the remote controller 20 is processing of a karaoke tune play request. When a karaoke tune play request is present in the karaoke terminal 10, the karaoke terminal 10 performs the following processing under control by the controller 18. The controller 18 reads out the MP3 stream data, encoded moving picture data of a background image and words data from the HDD and transmits the MP3 stream data to the audio processor 15 and the encoded moving picture data and words data to the image processor 14. The image processor MPEG decodes the encoded moving picture data to reproduce a background image (moving picture), superimposes the image of words corresponding to the words data on the moving picture, and displays the resulting picture on the display section 12. The audio processor 15 decodes the MP3 stream data and outputs an audio signal obtained through decoding from the loudspeaker 15a. In this embodiment, an infrared signal received by the infrared communications section 11 may include the IP address of the remote controller 20. In this case, the controller 18 stores the IP address extracted from the infrared signal into the storage section 16 and thereafter the remote controller 20 uses the IP address in the storage section 16 as a destination address whenever it is necessary to perform communications with the remote controller 20 via a wireless LAN.

FIG. 3 is a block diagram showing the functional blocks of the remote controller 20. In FIG. 3, an infrared communications section 21 transmits an infrared signal-to the infrared communications section 11 of the karaoke terminal 10. The transmission power of the infrared signal in the infrared communications section 21 is suppressed to such a level that an infrared signal will reach the karaoke terminal 10 in the same room. A touch panel section 22 has, as is well known, a function of a display unit for displaying various information and a function of a pointing device.

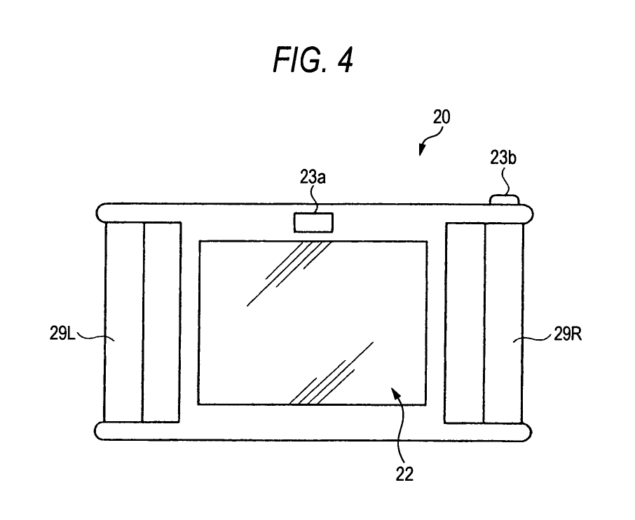

As shown in FIG. 4, the touch panel section 12 is provided on the front of the enclosure of the remote controller 20. A finder 23a for imaging is provided above the touch panel 22. Rod-shaped handlebars 23R and 23L to be held by the user's hands are provided on the right and left sides of the touch panel 22. A shutter 23b is provided above the section where the handlebar 29R is mounted on the enclosure of the remote controller 20. An imaging section 23 in FIG. 3 performs imaging of a person or scenery through the finder 23a when the shutter 23b is pressed, and generates the image data.

In FIG. 3, a wireless interface 24 controls communications with other apparatus via the wireless access point 40 and the LAN 30 shown in FIG. 1. In the embodiments, it is possible, by way of communications via the wireless access point 40 and the LAN 30, to transmit data from the remote controller 20 to the karaoke terminal 10, or transmit data from the karaoke terminal 10 to the remote controller 20. An image processor 25 synthesizes image data displayed on the touch panel section 22. An audio processor 26 generates voice based on the information received via the wireless LAN interface 24 and outputs the generated voice from a loudspeaker 26a. A storage section 27 includes a volatile memory such as a RAM and a nonvolatile memory such as a ROM. A control program and various types of data are stored in the nonvolatile memory in the storage section 27. An IP address IP-user for uniquely identifying the remote controller 20 is stored in the nonvolatile memory. The volatile memory in the storage section 27 is used as a work area of the controller 28. An area for storing the IP address of the karaoke terminal 10 as a communicating party is provided in the volatile memory. A controller 28 controls each section in the remote controller 20 in accordance with the control program stored in the storage section 27.

A primary control by the controller 28 includes a control in accordance with an instruction from the touch panel section 22 and control in accordance with an instruction from other apparatus received via the LAN interface 24. In this embodiment, the controller 28 has a function of, when a specific instruction concerning the remote operation of the karaoke terminal 10 is given via the touch panel section 22, adding the IP address IP-user in the storage section 27 to the instruction and transmitting the resulting instruction from the infrared communications section 21. In this embodiment, in case it is necessary to perform communications with the remote controller 20 via a wireless LAN, the karaoke terminal 1b transmits its IP address IP-host to the remote controller 20 via the LAN 30 and the wireless access point 40. The controller 28, upon receiving the IP address IP-host thus transmitted, stores the IP address IP-host into the storage section 27 and thereafter uses the IP address as a destination address to perform communications with the karaoke terminal 10 via a wireless LAN.

Operation of this embodiment will be described. In this embodiment, the remote controller 20 plays the same functions as a remote controller in a related art karaoke system, such as transmitting to the karaoke terminal 10 an infrared signal including the tune number input by the user. The karaoke terminal 10 plays the same functions as a karaoke terminal in a related art karaoke terminal, such as playing a karaoke tune corresponding to the tune number included in the infrared signal from the remote controller 20. In this embodiment, the operation described below is performed in addition to the operation where the remote controller 20 and the karaoke terminal 10 perform the same functions as those in the related art.

When the user places the finder 23a of the remote controller 20 toward user's face and presses the shutter 23b, an image of the user's face is imaged by the imaging section 23 and the image data is output from the imaging section 23. The controller 28 stores the image data of the user's face into the storage section 27. When the user operates the touch panel section 22 to input a tune number and an instruction to the effect that the image of his/her face be displayed on the display section 12 of the karaoke terminal 10, the controller 28 reads the IP address IP-user of the remote controller 20 from the storage section 27 and transmits the IP address together with the input information from the touch panel section 22 to the infrared communications section 21. The infrared communications section 21 transmits the information provided by the controller 28, that is, an infrared signal carrying a tune number, an instruction concerning display of the face and the IP address IP-user.

The infrared signal is received by the infrared communications section 11 of the karaoke terminal 10 in the same room as the remote controller 20. The infrared communications section 11 extracts the tune number, the instruction concerning display of the face and the IP address IP-user from the received infrared signal and transmits these data to the controller 18. The controller 18 stores the IP address IP-user as an address to identify the communicating party into the storage section 16. Based on the fact that the information provided by the infrared communications section 11 includes an instruction concerning display of the face, the controller 18 inserts an instruction requesting image data used to display the face into a packet whose source address is the IP address IP-host of the karaoke terminal 10 and whose destination address is the IP address IP-user, then transmits the packet from the LAN interface 17. The packet reaches the remote controller 20 identified by the destination address IP-user via the LAN 30 and the wireless access point 40.

When the LAN interface 24 of the remote controller 20 receives this packet, the controller 28 stores into the storage section 27 the source address IP-host included in the packet as an address to identify the karaoke terminal 10 as a communicating party. An instruction to request image data necessary to display a face is included in the packet. Thus the controller 28 reads the image data of the user's face from the storage section 27 and instructs to the wireless LAN interface 24 transmission of the image data to the karaoke terminal 10. In accordance with this instruction, the wireless LAN interface 24 inserts image data into a packet whose destination address is the IP address IP-host of the karaoke terminal 10 and whose source address is the IP address IP-user of the remote controller 20, and then transmits the packet. The packet reaches the karaoke terminal 10 identified by the destination address IP-host via the wireless access point 40 and the LAN 30.

When the LAN interface 17 of the karaoke terminal 10 receives this packet, the controller 18 extracts image data from the received packet and passes the image data to the image processor 14. In parallel with this operation, the controller 18 reads from the HDD the tune data of a karaoke tune corresponding to the tune number previously received by the infrared communications section 11 thus performing playback control of the karaoke tune. In this practice, the controller 18 transmits the MP3 stream data in the tune data to the audio processor 15 and words information to the image processor 14. The image processor synthesizes the image data of the user's face previously provided by the controller 18 and image data of words corresponding to the words information, and displays the data on the display section 12. As a result, the words are displayed with the user's face appearing as a background image.

As mentioned hereinabove, according to this embodiment, when a specific instruction for processing including communications via a wireless LAN is transmitted from the remote controller 20 to the karaoke terminal 10 over an infrared signal, the IP address of the remote controller 20 is transmitted to the karaoke terminal 10 over the same infrared signal. While it is not guaranteed to use the remote controller 20 always in the same room, the karaoke terminal 10 of the embodiment can extract the IP address of the remote controller 20 which has transmitted an infrared signal from the infrared signal and use the IP address to perform communications with the remote controller 20 via a wireless LAN.

Other embodiments of the invention are described below.

(1) In the foregoing embodiments, an operation example is described where image data is transmitted to the karaoke terminal 10 from the remote controller 20 via a wireless LAN. In this embodiment, the karaoke terminal 10 can acquire the IP address of the remote controller 20 which has transmitted an infrared signal. The remote controller 20 can acquire the IP address of the karaoke terminal 10 in case it has received some packet data from the karaoke terminal 10 via a wireless LAN. Thus, bidirectional communications is allowed via a wireless LAN between the karaoke terminal 10 and the remote controller 20. As a result, data may be transmitted from the karaoke terminal 10 to the remote controller 20 via a wireless LAN.

The following operation is conceived as an example of this operation. The user operates the touch panel section 22 of the remote controller 20 to input a tune number as well as an instruction for operation in the trial mode. The trial mode is an operation mode where karaoke playback instructed by the operation on the remote controller 20 is not made on the karaoke terminal 10 but on the remote controller 20. Same as the above embodiments, information input via the touch panel section 22 is transmitted, together with the IP address IP-user of the remote controller 20, by the infrared communications section 21 to the karaoke terminal 10. The controller 18 of the karaoke terminal 10 reads from the HDD the MP3 stream data, encoded moving picture data of the background image and words data of the karaoke tune corresponding to the tune number received from the remote controller 20. The controller 18 then MPEG decodes the encoded moving picture data to reproduce the background image (moving picture) and superimposes thereon the image of words data corresponding to words data. The controller 18 also decodes the MP3 stream data. The controller 18 MPEG encodes the background image (moving picture) where the words image is superimposed and the voice data decoded from the MP3 stream data to generate stream data, insets the stream data into a packet, and transmits the packet to the remote controller 20 via a wireless LAN. The remote controller 20 extracts the stream data from the received packet and the image processor 25 decodes the words and background image, which are displayed on the touch panel section 22. In the audio processor 26, voice is decoded from the stream data and output from the loudspeaker 15a. The user checks the sound and the image, and if the user likes the karaoke tune, specifies the tune number of the same tune on the remote controller 20 to instruct the karaoke terminal 10 karaoke playback in a regular operation mode, not the trail mode. The above operation may be made not only in the trial mode but also in the regular karaoke playback.

The tune data track of the tune data of a karaoke tune may comprise MIDI data. In this case, such a configuration is possible that the voice data of the performer is generated based on the MIDI data on the karaoke terminal 10 and the background image (moving picture) where the image of words is superimposed and the voice data are MPEG encoded, then the resulting stream data is transmitted to the remote controller 20 via a wireless LAN.

(2) In the above embodiment, when a predetermined instruction is transmitted to the karaoke terminal 10 over an infrared signal, the IP address of the remote controller 20 is also transmitted to the karaoke terminal 10 over the same infrared signal. A trigger that the IP address is transmitted from the remote controller 20 to the karaoke terminal 10 may be in various implementations. For example, such a configuration is conceived where an infrared signal carrying the IP address of the remote controller 20 is transmitted to the karaoke terminal 10 when the remote controller 20 is powered or when it is initialized and thereafter the IP address is used to perform data communications via a wireless LAN from the karaoke terminal 10 to the remote controller 20.

The control program for the remote controller 20 may be configured so that the IP address of the remote controller 20 will be transmitted to the karaoke terminal 10 without fail. For example, the following implementation is possible. When the user turns on the power switch of the remote controller, the controller 28 of the remote controller 20 displays on the touch panel section 22 a guidance screen including a message “Welcome. Please press the button,” and a soft button. The controller 28, detecting that the user's finger has touched the soft button, displays a well-known guidance screen for reservation of a karaoke tune on the touch panel section 22. At the same time, the controller 28 reads the IP address IP-user of the remote controller 20 stored in the storage section 27 and transmits the address IP-user to the karaoke terminal 10 by way of the infrared communications section 21.

The remote controller 20 may be configured so that the power will be turned off when a predetermined time has elapsed without any operation made on the touch panel section 22 and the power will be turned on when the user's finger has touched the touch panel section 22. On the remote controller 20 thus configured, the IP address IP-user of the remote controller 20 may be transmitted to the karaoke terminal 10 by way of the infrared communications section 21 when the power is turned on by a contact of the user's finger with the touch panel section 22.

The remote controller 20 may be configured so that, in case a specific instruction is input from the touch panel section 22, the IP address IP-user will not be transmitted to the karaoke terminal 10 even incase a trigger for transmitting the IP address IP-user is reached.

(3) In the above embodiment, information transmitted from a remote controller to a karaoke terminal in a related art karaoke system is transmitted to the karaoke terminal via infrared communications, same as the related art. The information communicated via infrared communications may be separated from the information communicated via a wireless LAN in other ways. For example, only the IP address IP-user of the remote controller 20 may be transmitted to the karaoke terminal 10 via infrared communications, thereafter all information may be communicated between the remote controller 20 and the karaoke terminal 10 via a wireless LAN.

(4) In the above embodiment, the remote controller 20 transmits an IP address itself to the karaoke terminal 10 via the infrared communications. Instead of transmitting the IP address, identification information to uniquely identify the remote controller 20 may be transmitted to the karaoke terminal 10 via infrared communications and the karaoke terminal 10 may convert the identification information received from the remote controller 20 to an IP address by using a previously stored conversion table for converting the identification information of each remote controller 20 to an IP address.

(5) While the infrared communications are used as an example of short range communications in the above embodiment, any other schemes of communications may be used as short range communications between a remote controller and a karaoke terminal.

(6) The invention is applicable to not only a karaoke system but also all communications systems where both short range communications and communications via a wireless network such as a wireless LAN are made between a remote controller and a service terminal.

1. A communications system comprising:
a network including a wireless access point;
a plurality of service terminals that are respectively connected to the network and respectively provided with a short range wireless receivers that receive a radio signal; and
a movable user terminal that includes a short range wireless transmitter for transmitting a radio signal and a wireless network connection unit that performs wireless communication with the wireless access point,
wherein, when the short range wireless receiver of one of the plurality of service terminals receives the radio signal representing identification information of the movable user terminal transmitted by the short range wireless transmitter, the one of the plurality of service terminals transmits a communication address of the one of the plurality of service terminals to the movable user terminal specified by the identification information through the network, and the movable user terminal are communicated with the one of the plurality of service terminals through the network with using the communication address.

2. The communications system according to claim 1, wherein the network is LAN, the communication address is an IP address of the one of the plurality of service terminals and the identification information is an IP address of the movable user terminal.

3. The communications system according to claim 1, wherein the short range wireless transmitter transmits the identification information to the short range wireless receiver through a infrared data communication.

4. A communications apparatus comprising:
a short range wireless receiver that receives a radio signal;
a communications unit that performs communications via a network; and
a controller that transmits, upon receiving the radio signal representing identification information through the short-range wireless receiver, a communication address of the communications apparatus to a device identified by the identification information through the network by way of the communications unit, and performs communications with the device through the network.

5. The communications apparatus according to claim 4, wherein the network is LAN, the communication address is an IP address of the communications apparatus and the identification information is an IP address of the device.

6. The communications apparatus according to claim 4, wherein the short range wireless receiver receives an infrared radio signal.

7. A communications apparatus comprising:
a wireless network connection unit that performs wireless communications with a wireless access point provided on a network;
a short range wireless transmitter that transmits a radio signal; and
a controller that transmits identification information of the communications apparatus through the short range wireless transmitter, receives a communication address transmitted by a service terminal which has received the identification information through the wireless network connection unit via the network and the wireless access point, and performs communications with the service terminal which has received the identification information by using the communication address.

8. The communications apparatus according to claim 7, wherein the network is LAN, the communication address is an IP address of the service terminal and the identification information is an IP address of the communications apparatus.

9. The communications apparatus according to claim 7, wherein the short range wireless transmitter transmits an infrared radio signal.

10. A method of communication between a service terminal and a movable user terminal, wherein the service terminal is connected to a network including a wireless access point and includes a short range wireless receiver for receiving a radio signal, and a movable user terminal includes a short range wireless transmitter for transmitting a radio signal and a wireless network connection unit that performs wireless communication with the wireless access point, the method comprising:
transmitting the radio signal representing identification information of the movable-user terminal by the short range wireless transmitter;
receiving the radio signal representing identification information by the short range wireless receiver;
transmitting a communication address of the service terminal to the movable user terminal specified by the identification information through the network;
receiving the communication address by the wireless network connection unit; and
performing wireless communication between the service terminal and the movable user terminal through the network with using the communication address.
